(19) United States
(12) Patent Application Publication
(10) Pub. No.: US 2026/0360683 A1
(43) Pub. Date: Nov. 12, 2026

(54) Survey Mode for Imaging Mass Cytometry

(71) Applicant: Standard Bio Tools Canada Inc., Markham (CA)

(72) Inventor: Alexander LOBODA, Markham (CA)

(73) Assignee: Standard Bio Tools Canada Inc., Markham, ON (CA)

(21) Appl. No.: 19/488,698

(22) PCT Filed: May 30, 2024
(86) PCT No.: PCT/IB2024/055307

§ 371 Date: Nov. 28, 2025

Related U.S. Application Data
(60) Provisional application No. 63/469,801, filed on May 30, 2023.

(51) Int. Cl. H01J 49/16; H01J 49/00

(52) U.S. Cl. CPC H01J 49/161; H01J 49/0027

(57) ABSTRACT

In one aspect, a method of imaging a biological specimen is disclosed, which includes defining a plurality of reference location points across a surface of the biological specimen, directing ablating radiation to the biological specimen at a first plurality of sample locations corresponding to a first subset of the defined reference location points to ablate at least a portion of the specimen at each of said locations, thereby generating a gas phase sample from each of said sample locations, ionizing each of the gas phase samples to generate ions corresponding to that gas phase sample, acquiring one or more mass signals corresponding to ions associated with each of the ablated portions, and identifying at least one region of interest based on analysis of the mass signals. An image of the identified region of interest can be acquiring using image mass cytometry.

### RELATED APPLICATIONS

This application claims the benefit of U.S. Provisional Patent Application No. 63/469,801, filed on May 30, 2023, the contents of which are incorporated herein by reference in their entirety.

### BACKGROUND

The present teachings are generally directed to imaging of biological specimens using, e.g., Imaging Mass Cytometry™ (IMC™).

IMC™ is employed for analysis of a variety of specimens, such as imaging of biological materials. In IMC™, a specimen under analysis is ablated by laser radiation and the ablated material is ionized, e.g., in an inductively coupled plasma, to generate ions, which are detected and analyzed via mass spectrometry. In analysis of biological specimens, IMC™ can be used in conjunction with the use of metal-labeled antibodies that exhibit specific binding to target cells of interest to identify cell types of interest within the specimen.

The imaging of biological specimens using IMC™ is conventionally performed using ablation spot sizes that are 1 micron or less. The use of ablation spot sizes that are equal or less than 1 micron is considered as being essential for obtaining useful images from which the desired biological information can be gleaned.

Notwithstanding significant progress that has been made in the field of IMC™, certain challenges remain, such as long data acquisition times of low signals per pixel for a number of low signal strength markers.

### SUMMARY

In one aspect, a method of imaging a biological specimen is disclosed, which comprises defining a first plurality of reference location points across a surface of the biological specimen, directing ablating radiation to the biological specimen to ablate a fraction of the specimen at a first plurality of specimen locations corresponding to the defined first reference location points or a subset thereof to ablate at least a portion of the specimen at each of said first plurality of specimen locations, thereby generating a gas phase sample from each of said first plurality of specimen locations, ionizing each of the gas phase samples to generate ions corresponding to that gas phase sample, acquiring one or more mass signals corresponding to ions associated with each of the ablated portions, and identifying at least one region of interest based on analysis of the mass signals.

In various embodiments, the step of identifying the at least one region of interest comprises comparing each of the mass signals with at least one threshold reference defined based on at least one phenotypic signal to determine whether the specimen location corresponding to that mass signal is within the region of interest.

In various embodiments, the at least one phenotypic signal comprises a plurality of phenotypic signals and the at least one threshold reference comprises a plurality of threshold references each corresponding to one of the phenotypic signals and the method can further comprise classifying each of the ablated locations in a multidimensional signal space based on said comparison.

In various embodiments, the method can further comprise performing a neighborhood analysis of the classified ablated locations to identify the at least one region of interest. For example, and without limitation, in some cases, the at least one region of interest can be identified without utilizing fluorescent imaging.

In various embodiments, the method can further comprise utilizing any of image mass cytometry and image mass spectrometry to generate an image of the identified region of interest.

In various embodiments, the ablating radiation is configured to ablate a top layer of the specimen at one or more of said first plurality of locations. By way of example, and without limitation, the top layer can have a thickness in a range of about 10 nm to about 1000 nm.

In various embodiments, an image of the identified region of interest can be obtained by directing ablating radiation to a second plurality of locations within the region of interest to generate a gas phase sample from each of said second plurality of portions, ionizing the gas phase samples to generate ions corresponding to each of said second plurality of specimen locations, acquiring one or more mass signals corresponding to ions associated with each of the second plurality of specimen locations, and generating an image of at least a portion of the region of interest based on said mass signals associated with said second plurality of specimen locations. In some such embodiments, the ablation radiation can be directed to the second plurality of locations without re-registration of the radiation relative to the defined reference location points.

The biological specimen can include one or more cell types. In various embodiments, the generation of the image can comprise analyzing the mass signal associated with each of the second plurality of specimen locations to identify one or more cell types of interest in that location. By way of example, and without limitation, the cell types of interest can include any of immune cells, structural cells, tumor cells, stroma cells, germinal center cells, blood vessel cells, mesenchymal cells or non-mesenchymal cells. For example, the immune cells can comprise any of CD3+ and CD45+ cells. In some cases, the second plurality of locations can be different from the first plurality of locations. In some cases, the second plurality of locations can contain the first plurality of locations.

In various embodiments, the identification of the one or more cell types of interest is based on identification of at least a phenotypic signal via analysis of the mass signal associated with each of the second plurality of specimen locations. By way of example, and without limitation, the at least one phenotypic signal is associated with any of a target protein, a target DNA, a target RNA, a target molecular structure, a sequence of amino acids, a target lipid structure, a target phosphorylation region, a target sugar region, a naturally occurring substance or element. For example, and without limitation, the naturally occurring substance or element comprises any of Selenium and Mercury. In some cases, the at least one phenotypic signal is associated with a drug related substance. In some cases, the at least one phenotypic signal is associated with platinum in a chemotherapy drug. In some cases, the at least one phenotypic signal provides information regarding protein content of different cell types, or tissue compartments.

In various embodiments, the identification of any one of the one or more cell types of interest is based on detection of a mass signal corresponding to a metal tag coupled to an antibody exhibiting specific binding to a surface marker of that cell type of interest.

In various embodiments, the plurality of reference location points is distributed according to a regular grid. By way of example and without limitation, the regular grid can be any of a rectangular, a square, a triangular, and a hexagonal grid.

In various embodiments, any of the first and the second ablated locations have a maximum linear dimension in a range of greater than 1 micron to about 20 microns. For example, and without limitation, the maximum linear dimension can be any of at least 2 microns, at least 3 microns, at least 4 microns, at least 5 microns, at least 6 microns, at least 7 microns, at least 8 microns, at least 9 microns, at least 10 microns, at least 11 microns, at least 12 microns, at least 13 microns, at least 14 microns, at least 15 microns, at least 16 microns, at least 17 microns, at least 18 microns, at least 19 microns, and at least 20 microns.

In various embodiments, the first ablated locations are separated from one another by a distance corresponding to a multiple of the maximum linear dimension. By way of example, and without limitation, the multiple can be in a range of 2 to 10.

In various embodiments, the first and the second ablated locations can have a substantially circular cross-sectional profile and the maximum linear dimension corresponds to a diameter of said substantially circular cross-sectional profile.

In various embodiments, the second set of ablated locations can be positioned side-by-side.

A method according to the present disclosure can be utilized to image a variety of biological specimens. By way of example and without limitation, the biological specimen can include any of a tissue specimen, a bone section, a blood specimen, an organoid section, a cell culture specimen.

In various embodiments, the radiation utilized for surveying and/or imaging the specimen can be laser radiation, e.g., pulsed laser radiation. By way of example, and without limitation, the laser radiation can have a wavelength in a range of about 10 nm to about 10000 nm, e.g., in a range of about 100 nm to about 1000 nm. In some such embodiments, the laser radiation can have a beam size at a surface of said specimen in a range of about 1 micron to about 20 microns. Further, the laser radiation can have a fluence in a range of about 0.001 J/cm² to about 10 J/cm² at the surface of the specimen.

In various embodiments, the laser radiation can have a Gaussian intensity profile and the beam size can correspond to a full width at half maximum (FWHM) of the Gaussian intensity profile.

In various embodiments, the laser radiation can have a flat top intensity profile.

In various embodiments, the ablating radiation is configured to generate a substantially uniform ablation of said plurality of locations.

In various embodiments, a mass spectrometer can be utilized for generating the mass signals corresponding to any of said first and said second plurality of specimen portions. By way of example, and without limitation, the mass spectrometer can be a high-parameter mass spectrometer, such as a ToF mass spectrometer.

In various embodiments, an optical image of the biological specimen can be generated with a trace delineating the identified region of interest. In some such embodiments, a display of a user interface can be employed to present the optical image to a user. Further, in various embodiments, the user interface is configured to allow a user to select locations within the identified region of interest for imaging.

In various embodiments, a digital data processor can be utilized to analyze the mass signals for identification of the region of interest.

In various embodiments, the specimen can be placed on a specimen holder and the specimen holder can be moved, e.g., during the survey and/or imaging periods, relative to the radiation (e.g., relative to laser radiation pulses) to direct the radiation to any of the first and the second plurality of specimen locations.

In various embodiments, the radiation can be a pulsed laser radiation and a plurality of radiation pulses can be directed to at least one of said locations for causing ablation of a least a portion of the specimen at that location. By way of example, and without limitation, the laser radiation pulses can be directed to each location at a repetition rate in a range of about 10 kHz to about 10000 kHz.

In various embodiments, rather than or in addition to moving the specimen relative to the radiation, the radiation can be directed as a radiation beam to the biological specimen and the radiation beam can be moved relative to the specimen, e.g., relative to a holder on which the specimen is positioned, to ablate any of the first and the second specimen portions.

In a related aspect, a method of identifying at least a region of interest associated with a biological specimen is disclosed, which comprises ablating a plurality of portions of the specimen with radiation to create a gas phase sample from each portion, ionizing at least a portion of the gas phase sample from each of the plurality of said specimen portions to generate ions associated with the two or more of the specimen portions, acquiring mass signals corresponding to the ions associated with the two or more specimen portions, and identifying the at least one region of interest based on analysis of the mass signals associated with the two or more specimen portions.

In various embodiments, the step of analyzing the mass signals can include comparing each of the mass signals with a reference threshold to determine whether a respective portion of the specimen is part of the region of interest. By way of example, and without limitation, a specimen portion can be classified as being in the region of interest when the mass signal associated with that specimen portion is equal to or greater than the reference threshold.

In various embodiments, the analysis of the mass signals can include comparing two or more specimen portions with one another to determine if any of said two or more specimen portions is part of the region of interest.

In various embodiments, the analysis of the mass signals can include comparing the mass signal associated with at least one of the specimen portions with a mass signal associated with a neighboring specimen portion.

In various embodiments, the analysis of the mass signals can include classifying any of the specimen portions as being in the region of interest when the mass signal associated with that specimen portion is within a predefined range.

In various embodiments, the collection of the plurality of specimen portions corresponds to a fraction of the specimen. In other words, the plurality of specimen portions do not collectively encompass the entire specimen.

In various embodiments, each of the specimen portions has a maximum linear dimension of greater than 1 μm, and optionally in a range of greater than 1 μm to about 20 μm, e.g., a maximum linear dimension of at least 2 μm, or at least 3 μm, or at least 4 μm, or at least 5 μm.

In various embodiments, a digital data processor can be utilized to perform the analysis of the mass signals.

In various embodiments, the specimen portions can be arranged relative to one another according to a regular grid, such as any of a square, a rectangular, a triangular and a hexagonal grid.

In various embodiments, the method can further include functionalizing said biological sample with at least one antibody tagged with at least one metal tag, wherein said antibody exhibits specific binding to a target surface cell marker. In such embodiments, the ionization step can include ionizing the metal tag. An image of at least a portion of the identified target region can be generated using mass signals associated with said at least one metal tag.

In various embodiments, the above method can be practiced on a variety of biological specimens. By way of example, the biological specimen can include any of a tissue specimen, a bone section, a blood specimen, an organoid section, and a cell culture specimen.

In a related aspect, a method of identifying one or more regions of interest of a biological specimen is disclosed, which comprises: (a) ablating a portion of a specimen with radiation to create a gas phase sample, (b) ionizing at least a portion of the gas phase sample, (c) generating a mass spectrum comprising at least one mass signal from the ionized portion of the gas phase sample, (d) comparing the at least one mass signal to at least one threshold value defined based on at least one phenotypic signal, (e) identifying the ablated portion as part of a region of interest when said at least one mass signal is equal to or greater than the threshold value to which that mass signal is compared, (f) repeating steps (a) to (e) for one or more different portions of the biological specimen, and (g) identifying one or more regions of interest of the biological specimen based on two or more of the ablated portions identified as part of a region of interest.

In various embodiments, in the above method, the at least one mass signal can include a plurality of mass signals.

In various embodiments, in the above method, the at least one phenotypic signal can include a plurality of phenotypic signals. In some such embodiments, each of the phenotypic signals can be compared to a respective one of a plurality of threshold values.

In various embodiments, a substantially complete image of the identified one or more regions of interest can be acquired. In some such embodiments, the substantially complete image of the identified one or more regions of interest can be acquired without re-ablating the portions of the specimen that were ablated for identifying the one or more regions of interest.

In various embodiments, the at least one phenotypic signal is associated with any of a target protein, a target DNA, a target RNA, a target molecular structure, a sequence of amino acids.

In various embodiments, the specimen portions ablated to identify the one or more regions of interest are separated from one another by a distance that is a multiple of a maximum linear dimensional size of the ablated portions. By way of example, the multiple can be in a range of about 2 to about 7.

In a related aspect, a method of generating a three-dimensional tomographical image of a biological specimen is disclosed, which comprises defining a plurality of sections of the biological specimen. For each of the sections, the following steps can be performed: defining a plurality of reference location points across a surface of the biological specimen, directing ablating radiation to the biological specimen at a first plurality of sample locations corresponding to a first subset of the defined reference location points to ablate at least a portion of the specimen at each of said locations, thereby generating a gas phase sample from each of said sample locations, ionizing each of the gas phase samples to generate ions corresponding to that gas phase sample, acquiring one or more mass signals corresponding to ions associated with each of the ablated portions, identifying at least one region of interest based on analysis of the mass signals, and generating an image of said at least a portion of the identified at least one region of interest.

In various embodiments, the step of generating the image of the identified at least one region of interest can comprise: directing ablating radiation to a second plurality of locations within the region of interest and associated with a second subset of said reference location points to generate a gas phase sample from each of said portions, ionizing said gas phase samples to generate ions corresponding to each of said second plurality of specimen locations, acquiring one or more mass signals corresponding to ions associated with each of the second plurality of specimen locations, and generating the image of the at least a portion of the region of interest based on said mass signals associated with said second plurality of specimen locations.

In a related aspect, a method of imaging a biological specimen is disclosed, which comprises: obtaining an optical image of a biological specimen disposed on a holder, directing ablating radiation to a plurality of portions of said biological specimen to generate a gas phase sample from each of said portions, ionizing said gas phase samples to generate ions corresponding to each of said plurality of specimen locations, acquiring one or more mass signals corresponding to ions associated with each of the plurality of specimen locations, and generating the image of at least a portion of the biological specimen based on said mass signals associated with said plurality of specimen locations.

Further understanding of various aspects of the present teachings can be obtained by reference to the following detailed description in conjunction with the associated drawings, which are described briefly below.

### BRIEF DESCRIPTION OF THE DRAWINGS

FIG. 1A is a flow chart depicting various steps in a method according to an embodiment of the present teachings,

FIG. 1B shows a microscope slide on which a tissue specimen is disposed,

FIG. 2A is a view of the microscope slide with a plurality of reference location points superimposed on the image of the microscope slide for defining a plurality of locations to be ablated for fractional sampling of the tissue specimen,

FIG. 2B schematically depicts a plurality of laser shots with 1 micron spacing utilized in a conventional method of performing imaging mass cytometry,

FIG. 2C schematically depicts a plurality of laser shots at 5-micron center-to-center spacing according to an embodiment, which provides a 25× throughput relative to the conventional method depicted in FIG. 2B,

FIG. 2D schematically depicts a plurality of laser shots at 5.88 micron center-to-center spacing according to another embodiment, which provides a 30× throughput relative to the conventional method depicted in FIG. 2C,

FIG. 2E schematically shows a survey mode in which laser shots at 5 μm spacing and ~10 dB energy are used with minor gaps separating the laser shots,

FIG. 2F shows a fractional sampling survey mode in which laser shots at ~25 μm spacing and ~10 dB energy are utilized,

FIG. 2G schematically depicts a minimal sampling survey mode in which laser shots at ~25 μm spacing and an energy of ~10 dB was used, but the laser beam was defocused such that only the top 10% of the material is sampled within a 10 μm area,

FIG. 3 is a view of the microscope slide delineating a region of interest identified using methods according to an embodiment of the present teachings,

FIG. 4 is a view of the microscope slide depicting various locations within the region of interest that are selected for imaging,

FIG. 5 is a schematic view of an imaging system according to an embodiment of the present teachings,

FIG. 6 is an example of a workflow that can be employed in some embodiments of the present teachings,

FIGS. 7A, 7B, 7C, and 7D show a plurality of pseudo cells classified based on selected phenotypic signals associated with one exemplary marker (CD3), and

FIGS. 8A and 8B show other examples of pseudo cells identified based on phenotypic signals associated with a plurality of makers.

### DETAILED DESCRIPTION

The present teachings are generally directed to methods and systems for generating an image of a specimen, and in particular, a biological specimen, using IMC™. Conventionally, such images are generated via ablation of micrometer and sub-micron portions of a specimen to generate gas phase samples that can be ionized to generate ions that can be detected and analyzed using mass spectrometry. It is generally accepted in the art that the formation of an image that would provide useful information regarding a sample, e.g., the distribution of various cell types in the sample, requires the use of ablation spots (herein also referred to as pixels) with sizes that are equal to 1 micron or less to ensure that the specimen can be interrogated at sub-cellular spatial resolution. Such a conventional approach, however, leads to long data acquisition times. Moreover, in conventional systems, because of a lower throughput, a user typically selects a portion of the specimen for imaging. The selection of a portion of a specimen to be imaged is made manually by the user, which can lead to selection bias and also adds to the overall time required to obtain an image.

In this disclosure, methods and systems for selection of a region of interest (ROI) of a specimen and imaging that region are disclosed that in contrast to conventional teachings, employ large ablation spot sizes, e.g., greater that 1 micron, for scanning a specimen. Moreover, once a region of interest has been identified, that region or a portion thereof can be imaged using ablation spots where each ablation spot causes ablation of a portion of the specimen (herein such ablation portions are also referred to as pseudo cells) to generate a gas phase sample, which can be ionized and analyzed using mass spectrometry to obtain an image of the interrogated region. It has been surprisingly discovered that such large ablation spot sizes can be utilized for scanning the specimen to identify a region of interest as well as for imaging that region and extracting useful biological information. In particular, contrary to conventional understanding in the art, it has been surprisingly discovered that the mass data acquired via such large ablation spots can be processed to generate an image that provides various desired information regarding the specimen, e.g., the distribution of cell types of interest within the specimen. For example, in various embodiments, “pseudo cells” (e.g., 5 μm diameter spots) can be classified, e.g., based on phenotypic signals, followed by performing neighborhood analysis of the distributions of pseudo-cells to extract biologically useful information about the specimen, as discussed in more detail below.

Various embodiments of the present teachings provide methods for imaging biological specimens utilizing the following data collection and analysis modes: (a) a fractional survey mode or fractional sampling mode (herein also referred to as a preview mode), (b) a survey mode (herein also referred to as a tissue mode), and (c) an IMC imaging mode (herein also referred to as a cell mode). In various embodiments, an ROI is identified in a preview mode, which can provide a rapid scan of an entire tissue specimen under analysis, e.g., via ablation of a sparsely distributed set of tissue spots (e.g., tissues spots having a spot size of about 1 micron and having a center-to-center separation of about 25 microns), and can identify one or more regions of interest, e.g., via detection of one or more markers of interest (e.g., one or more antibodies exhibiting specific binding to particular cell surface markers) in the ablation data. Subsequent to the identification of one or more regions of interest, in a tissue mode, the identified region(s) of interest are scanned via ablation of tissue spots having larger sizes and smaller center-to-center separations than those employed in the preview mode and the ablation data is analyzed, e.g., using pixel-clustering analysis. By way of example, in the tissue mode, the ablation spot size can be about 5 microns and the center-to-center separation between adjacent spots can be also about 5 microns. Following the tissue mode, a cell mode is initiated in which single-cell resolution imaging data is obtained via ablation of a plurality of tissue spots with smaller spot sizes than those employed in the tissue mode. By way of example, in the cell mode, the ablation spot sizes can be about 1 micron and the center-to-center separation of adjacent tissue spots can also be about 1 micron.

In various embodiments, in a fractional survey mode, a ROI is identified by ablation of a fraction of a specimen of interest. In various embodiments, in a fractional survey mode, the spacing between the ablation spot centers is on the same scale as the spot size, e.g., no greater than 150%, while in other embodiments, the spacing between ablation spots can be much larger. In a subsequent imaging mode, imaging mass cytometry or imaging mass spectrometry are utilized to image the ROI or a portion thereof. As noted above and discussed in more detail below, it has been discovered that the fractional survey mode can be performed with ablation spot sizes that are considerably larger than those that are conventionally employed. For example, it has been discovered that ablation sizes of greater than 1 micron can also be successfully employed in the imaging mode to image the ROI and derive desired biological information. The use of larger ablation spot sizes significantly improves the throughput of the system and also renders certain imaging modes (e.g., 3D imaging of a specimen) feasible that otherwise would be impractical, e.g., due to long data acquisition times.

In the following description, various aspects of the present teachings are described in connection with a tissue specimen, but it should be understood that the present teachings can be applied to obtain images of a variety of different specimens, including various biological specimens including those that contain cells, such as, tissue, and bodily fluids and excretions (such as, e.g., amniotic fluid, bile, whole blood, blood serum, blood plasma, cerebrospinal fluid, gastrointestinal fluid, interstitial fluid, mucus, pus, saliva, stool, tears, urine, etc.), by way of non-limiting examples.

Various terms are used herein according to their ordinary meanings in the art. The term “about” as used herein is intended to indicate a variation of at most 10% around a numerical value and the term “substantially” as used herein is intended to indicate a variation, if any, from a perfect, complete state and/or condition of at most 10%.

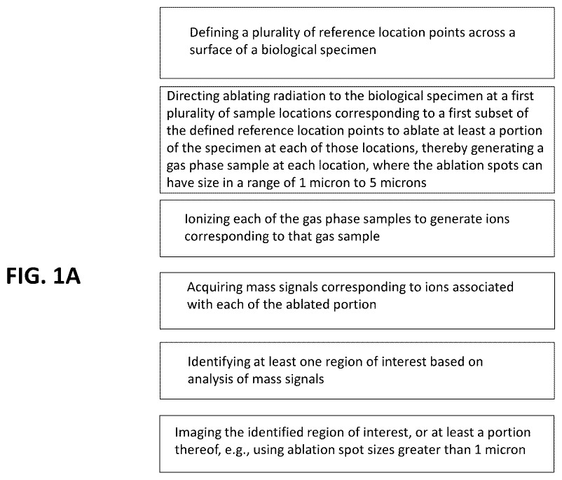

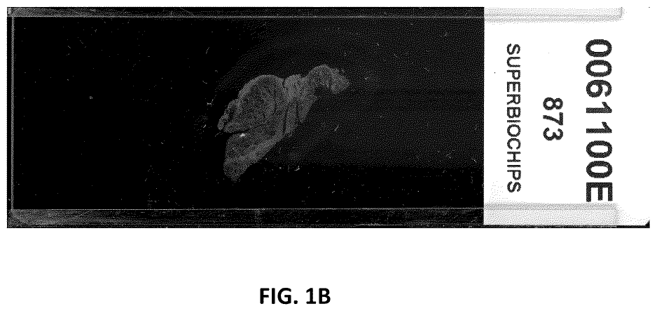

FIG. 1A is a flow chart providing various steps of an embodiment of a method according to the present teachings for generating an image of a biological specimen. The method includes defining, in a preview mode, a plurality of reference location points across a surface of the biological specimen, directing ablating radiation to the biological specimen at locations corresponding to the defined reference location points to ablate at least a portion of the specimen at each of those locations, thereby generating a gas phase sample from each of the specimen locations. The ablation spots can have a size, e.g., a diameter in a range of about 1 micron to about 10 microns. In various embodiments, the ablation spots can have a diameter in a range of about 1 micron to about 5 microns. A center-to-center separation of the ablation spots can be in a range of a factor of about 5 to a factor of about 50 of the ablation spot size (e.g., diameter). In various embodiments, the center-to-center separation of the ablation spots can be in a range of a factor of about 10 to a factor of about 50 of the ablation spot size. Thus, in some embodiments, the ablation spots can have a diameter of about 1 micron and can be spaced apart by a factor of about 25 of the diameter, i.e., about 25 microns center-to-center. The number and the sizes of the ablation spots and the spacing between the ablation spots are selected such that the ablation spots cover a fraction of an area that is scanned for the determination of an ROI.

Each of the gas phase samples is ionized to generate ions corresponding to that gas phase sample and one or more mass signals corresponding to the ions associated with each of the ablated portions are acquired. At least one region of interest is identified based on analysis of the mass signals. The region of interest, or at least a portion thereof, is imaged using, e.g., ablation spot sizes greater than about 1 micron, e.g., in various embodiments in a range of greater than 1 micron to about 5 microns.

FIG. 1B shows a tissue specimen 100 disposed on a microscope slide 102. As discussed in more detail below, the present teachings can be employed to identify one or more regions of interest associated with the tissue specimen 100 and further generate an image of the identified regions of interest utilizing imaging mass spectrometry (IMS) or imaging mass cytometry (IMC). In some cases, the entire tissue specimen may be the region of interest while in other cases a portion of the tissue specimen may be the region of interest. By way of example, in some cases, a region of the tissue specimen, if any, in which tumor cells are present may be the region of interest. Various embodiments of the present teachings allow identification of the regions of interest of the tissue specimen and generating one or more images of those regions.

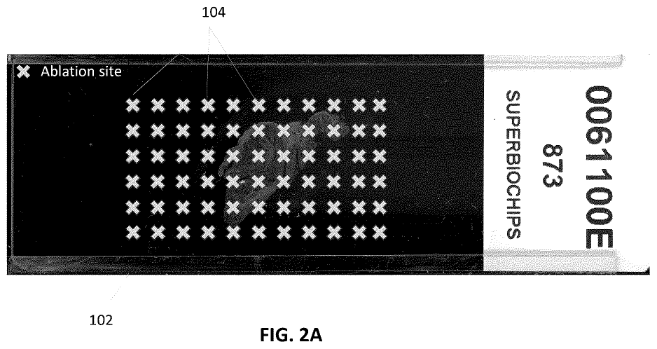

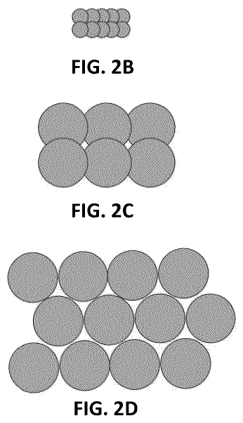

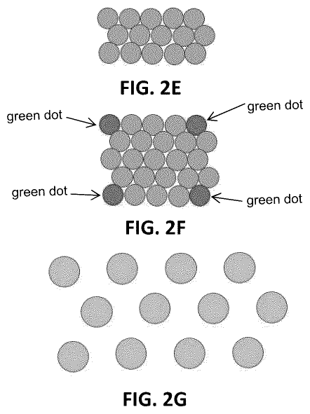

By way of example, with reference to FIG. 2A, in this embodiment, a plurality of reference location points 104 are defined across a portion of the slide 102, where each of the reference location points identifies a location to which an ablating radiation beam will be directed to cause ablation of at least a portion of the material at that location. In this example, the reference location points 104 are distributed across the slide as a rectangular regular grid. Although in this example a rectangular grid is utilized, in other embodiments other forms of regular grids, such as square, rectangular, triangular or hexagonal may be used. As discussed in more detail below, in various embodiments in which the size of an ablating radiation spot at the specimen surface is in a range of greater than 1 micron to about 10 microns, e.g., when the ablating radiation beam has a beam diameter in a range of greater than 1 micron to about 10 microns, the use of a hexagonal grid can be particularly advantageous.

More specifically, the use of a hexagonal ablation pattern can result in material ablation with less unablated material left between the ablated spots. To achieve the same level of ablation with a square tessellation, overlapping ablation spots would be generally required. For example, the use of a square ablation pattern may result in leaving areas in the corners of the specimen unablated, where the ablation of the unablated portions would require overlap of ablation spots. The use of overlapping ablation spots, however, results in an inefficient use of available laser energy. Moreover, during the fractional survey mode, overlapping ablation spots can create uneven signals. With hexagonal sampling and a proper choice of ablation spot diameter and sampling distances, the unablated material left can be minimized with the ablated spots exhibiting virtually no overlap.

By way of illustration, FIG. 2B schematically depicts a plurality of laser shots with 1 micron spacing utilized in a conventional method of performing imaging mass cytometry (also referred to as a cell mode). In contrast, FIG. 2C schematically depicts a plurality of laser shots at 5-micron center-to-center spacing according to an embodiment, which provides a 25× throughput relative to the conventional method depicted in FIG. 2B. FIG. 2D in turn schematically depicts a plurality of laser shots at 5.88 micron center-to-center spacing according to another embodiment, which provides a 30× throughput relative to the conventional method depicted in FIG. 2C. While the laser shot pattern shown in FIGS. 2B and 2C are based on a rectangular grid, the pattern depicted in FIG. 2D is based on a hexagonal grid, resulting in less unablated regions between the ablated spots while providing a higher throughput. A hexagonal pattern allows achieving a high throughput in combination with a low amount of material left in the unablated islands between the ablated spots.

FIG. 2E schematically shows a survey mode (also referred to as a tissue mode) in which laser shots at 5 μm spacing and ~10 dB energy are used with minor gaps separating the laser shots. FIG. 2F shows a fractional sampling survey mode (also referred to as a preview mode) in which laser shots at ~25 μm spacing and ~10 dB energy are utilized. The green dots represent the first pass of fractional sampling, which is followed by an imaging mode sampling after the identification of a region of interest. The signals collected from locations ablated in the first pass are substituted by the respective signals collected in the second pass imaging mode. FIG. 2G schematically depicts another type of survey mode—a minimal sampling survey mode. As an example of the minimal sampling survey mode the laser shots are placed at ~25 μm spacing and an energy of ~10 dB is used, but the laser beam is defocused such that only the top 10% of the material is sampled within a 10 μm area. This only removes a thin layer of the sample keeping the sample nearly intact. Once the ROI is identified, it can be imaged by any suitable imaging mass cytometry method, e.g., using side-by-side laser shots at 1 μm spacing or laser shots that are more sparsely distributed, e.g., in imaging mode with 5 μm spacing and ablation spot diameter.

A radiation beam can be registered with respect to the reference location points 104 and can be directed to each location identified by the reference location points to cause ablation of at least a portion of the material at that location.

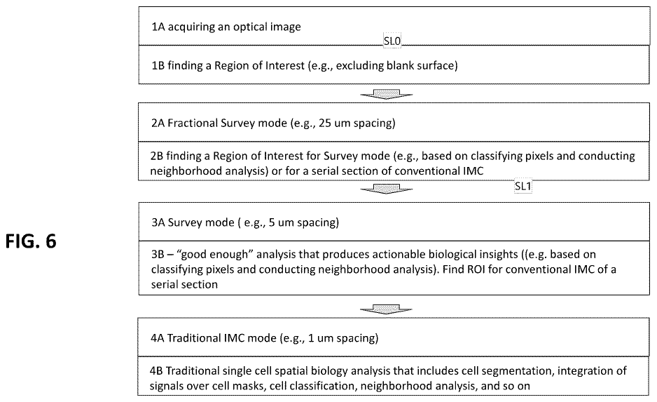

By way of example and with reference to the flow chart of FIG. 6, in some embodiments, a specimen of interest can be imaged optically and the optical image can be analyzed, in a manner known in the art, to identify an outline of the specimen with respect to the coordinates of a holder on which the specimen is positioned (steps 1A, 1B).

Subsequently, the locations that will be ablated during a fractional survey mode (i.e., a preview mode) for the purpose of identification of a region of interest within the contours of the specimen can be identified (step 2A). The identified coordinates can be transferred to an ablation system and a fractional survey of the specimen according to the present teachings can proceed via ablation of the specimen locations corresponding to the identified coordinates to identify one or more regions of interest associated with the specimen (step 2B). Alternatively, subsequent to the identification of the contour of the specimen via optical imaging, conventional IMC™ workflow (i.e., cell mode) can be utilized to identify one or more regions of interest (step 4A). Yet another approach is to move from step 1B to steps 2A/2B with minimal sampling survey mode (rather than fractional sampling survey mode) and then move from step 2B to step 4A.

In some cases, steps 1A and 1B can be performed on an IMC instrument by utilizing its optical sub-system. In an alternative approach, step 1A can be performed on an optical slide scanner. In yet another embodiment, steps 1A and 1B can be omitted and step 2A can be applied to an area, e.g., a rectangular area, where the specimen (e.g., a tissue section) is typically located. In such an approach, the possibility that the performance of step 2A may result in ablation of a large number of empty areas (i.e., areas of the holder on which no part of the specimen is positioned) is typically not of great concern when step 2A is performed with large ablation spacing at high throughput. For example, if needed, fractional survey sampling can first be done at a large spacing between consecutive ablation spots, e.g., a spacing of 100 microns, to speed up the task of finding the locations of the tissue on the holder (rather than finding an ROI for the survey mode). The data can be used at step 2B but with the aim of identifying an ROI for another round of step 2A (e.g., with a spacing of 25 microns between the spots). When the second fractional survey sampling is conducted it identifies the ROI for the survey mode (i.e., the tissue mode) to be conducted, e.g., at 5-micron spot size (See, steps 3A and 3B).

In various embodiments, the data collected during the fractional survey mode (i.e., the preview mode) of step 2A can be analyzed to identify ROIs at step 2B. For example, the collected data can be normalized and for each pixel, the data corresponding to that pixel and those within a defined neighborhood of that pixel can be analyzed with respect to signal(s) associated with one or more markers of interest (e.g., antibodies exhibiting specific binding to one more cell surface markers) to determine whether that pixel belongs to a region of interest. Such identified pixels can correspond to one or more regions of interest, i.e., the regions of the tissue specimen for which data will be acquired in the subsequent survey mode (i.e., tissue mode) of step 3A and IMC mode (i.e., cell mode) of step 4A.

This workflow resembles pyramidal data structures used in imaging of large areas. The first layer of pyramidal data contains top level image with coarse steps. The second layer contains data with finer steps. And the third layer would contain data with final spacing such that the imaging process consumes most of the sample material.

The above data acquisition workflow is not limited to three levels. Rather, more than three levels of data acquisition may be practiced if needed for certain applications. For instance, one can use factors of 2 or factors of 3 when changing spacing between the final narrow spacing and the course spacing. An example of 4 level pyramidal data would be to aim for a final spacing of 5 microns at the fourth layer, 15 microns at the third layer, 45 microns at the second layer and 135 microns at the first layer. Because the coordinates of the XY stage can be preserved with a precision of better than 1 micron (well below the smallest spacing of 5 microns), the data acquisition for each layer produces the data that can be also utilized as datapoints in subsequent layers.

In various embodiments, the radiation beam is a pulsed laser beam with a wavelength, e.g., in a range of about 10 nm to about 10000 nm. The sample holder, the glass slide in this example, can be scanned relative to the pulsed laser beam to expose each of the locations identified via the reference points to the laser radiation. In some embodiments, the laser beam can have a Gaussian profile with a beam size characterized by a full width at half maximum (FWHM) greater than 1 micron, e.g., in a range of greater than 1 micron to about 5 microns, such as, 2 microns, 3 microns, or 4 microns. In other embodiments, a flat top laser beam can be employed to provide a substantially uniform ablation of the ablated spots, as discussed in more detail below.

The irradiation of each of the locations across the microscope slide, including those locations on which the tissue specimen is positioned, leads to the ablation of at least a portion of the material at that location, i.e., the radiation vaporizes at least a portion of the material at that location, thereby generating a gas phase sample (herein also referred to as a gas phase plume) that can be analyzed in a manner discussed below, to determine whether that location is within a region of interest.

More specifically, in some embodiments, each gas phase sample can be carried via a carrier gas, e.g., helium, with high time fidelity into an ion source, e.g., an inductively coupled plasma ion source, in which at least a portion of the gas sample, e.g., one or more analytes and/or tags, are ionized and the ions are received and analyzed by a downstream mass analyzer, such as a time-of-flight (ToF) mass analyzer or any other suitable mass analyzer, which generates one or more mass signals associated with those ions. While in some embodiments mass cytometry or mass spectrometry systems can record ion signals of elements naturally present in the sample, in other embodiments mass cytometry systems employ antibodies stained with metal tags. In some other mass cytometry systems organic mass spectrometers are used for ionization and detection and as an example, ions of mass tags formed of intact peptides may be used.

In some embodiments, the tissue sample can be functionalized with one or more antibodies that include metal stable isotope tags. For example, a plurality of metal-tagged antibodies exhibiting specific binding to a plurality of surface markers associated with target cells of interest can be utilized. For example, metal-tagged antibodies that exhibit specific binding to CD3+ or CD45+ surface maker proteins can be utilized for identification of certain immune cells within the tissue sample. By way of example, and without limitation, such elemental tags can have a mass-to-charge ratio in a range of about 75 to about 209 m/z. The use of different tags allows identification of different cell types within the tissue sample.

In various embodiments, the metal tags associated with each ablated tissue location are concurrently measured and indexed to the respective locations. As discussed below, such detection of metal tags can allow identifying those tissue locations that are positioned within a region of interest.

More specifically, in one implementation of this embodiment, the tissue sample is scanned location-by-location along a raster scan line, and the gas plumes generated via ablation of the material at each location is ionized and mass analyzed, e.g., to identify the metal tags of interest to generate an intensity map of the target metal tags at the ablated locations.

The mass signals can then be employed to identify the locations corresponding to the tissue specimen relative to locations of the microscope slide on which no tissue is disposed. For example, when the mass signal corresponding to an ablated location shows no signal associated with any metal tag, or when the intensity of a mass signal associated with one or more metal tags is less than a predefined threshold, that location can be identified as corresponding to a microscope slide location on which no tissue sample is present and hence not a part of a target region of interest. Alternatively, the detection of mass signal(s) corresponding to one or more metal tags of interest can identify respective ablated locations as being part of the region of interest.

For example, in some embodiments in which it is desired to distinguish the locations associated with the tissue sample from those locations on the glass slide where no tissue is present (i.e., when the region of interest is the entire tissue sample), the detection of a mass signal corresponding to at least one of the metal tags can be used to identify the respective location as being part of the tissue sample.

In some embodiments, the region of interest may be a portion of the tissue sample in which one or more cell types of interest are present. In such cases, the mass signals can be used as phenotypic signals for identification of the target cells of interest. By way of example, when the regions of interest correspond to one or more portions of the tissue sample in which certain immune cells, e.g., immune cells exhibiting CD3+ and CD45+ surface markers, are present the mass signals corresponding to metal tags associated with antibodies that exhibit specific binding to those surface markers can be utilized to identify the presence of those cell types in the respective locations, thereby identifying those locations as being part of the region of interest. In some such cases, the respective locations are identified as being part of the region of interest only if the mass signals associated with the metal tags exhibit an intensity that exceeds a predefined threshold. In some cases, the respective locations are identified as being part of the region of interest when mass signals associated with one more tags exceed a first threshold and mass signals associated with certain other tags are below a second threshold, where the first and the second thresholds may be the same or different. By way of example, consider a cell type that can be characterized as CDn+, CDm−, CDo+, CDp−. In this example, such a cell type can be identified when the signals associated with tags for CDn and CDo mass channels are above the respective thresholds while simultaneously the signals associated with CDm and CDp mass channels are below their corresponding thresholds.

In some cases, a region of interest can be identified via detection of co-location or counter-location of two or more cell types. For example, the presence of two or more cell types of interest in a region can be used as criteria for identifying that region as a region of interest. As another example, the presence of one cell type and the absence of another cell type in a region can be used as the criteria for identifying that region as a region of interest. For example, a high abundance of immune cells together with a high abundance of cancer cells could indicate the region of interest. In another example, a high abundance of cancer cells with low abundance of immune cells could indicate the region of interest.

In this embodiment, rather than sampling the entire surface area of interest, only a portion of that surface is sampled via ablation of the above defined locations with the goal to identify one or more regions of interest. By way of example, the ablated locations can be separated from one another by a distance that is a multiple of the ablation spot size, e.g., a distance that is larger than the ablation spot size by a factor in a range of about 2 to about 7. For example, in some such embodiments, the distance between adjacent ablated locations can be about 25 micrometers with ablation spot size being set to 5 micrometers.

Further, it has been surprisingly found that the identification of the region(s) of interest can be achieved using a large ablating radiation beam size, i.e., a radiation beam having a spot size characterized by a diameter that is greater than about 1 micron (e.g., in a range of greater than 1 micron to about 10 microns). In other words, rather than utilizing a beam having a sub-cell size, a beam that can concurrently ablate adjacent portions of multiple cells at an ablation location can be utilized to identify a region of interest. The identification of the region of interest and in particular the use of a large radiation beam spot size together with sampling a fraction of an area of interest can significantly reduce the time required for data acquisition and identification of the region of interest.

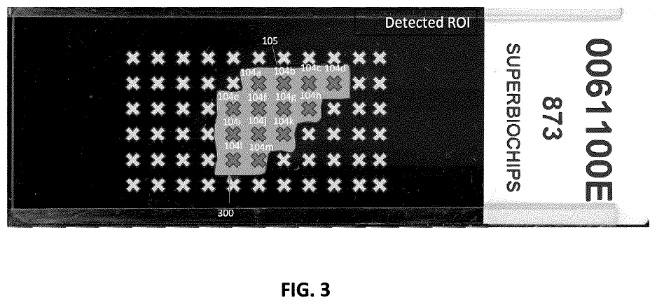

By way of illustration, FIG. 3 schematically shows an example of a region of interest 300 (the shaded area) associated with the tissue specimen 100 identified using an embodiment of the present teachings as discussed above. More specifically, the locations associated with the reference location points 104a, 104b, 104c, 104d, 104e, 104f, 104g, 104h, 104i, 104j, 104k, 104l, and 104m, are identified as being part of the region of interest. In this case, the region of interest is enclosed within a boundary 105, which surrounds the reference locations 104a-104m.

While in this example the region of interest is in the form of a contiguous region, in some cases, one or more disjoint regions of interest may be identified using the present teachings. By way of example, the regions of interest can be those in which at least one of two cell types of interest are present. In some such cases, one region of interest may contain one of those cell types while another region of interest (e.g., an overlapping or a disjoint region) may contain the other cell type.

In some embodiments, the ablation of various locations to determine whether those locations are part of a region of interest results in a partial, rather than a complete, ablation of the material at that location. For example, a top layer of the material, e.g., a layer having a thickness in a range of about 10 nm to about 1000 nm, may be ablated.

In some embodiments, upon identification of one or more regions of interest, an optical image of the tissue sample on which the region of interest is delineated, e.g., via a trace depicting the boundary of that region, can be displayed to a user. Further, a user interface can be presented to the user to allow the user, e.g., to manually select portions within the region of interest for which an image of the specimen, a tissue specimen in this example, are desired.

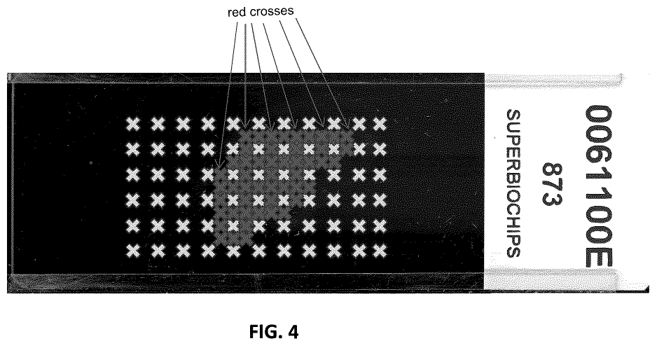

Once the region of interest is identified, an image of the region of interest (or a portion thereof) is acquired using imaging mass spectrometry. For example, with reference to FIG. 4, in the present embodiment, a radiation beam, e.g., the same radiation beam utilized for identifying the region of interest, can be directed to a plurality of locations within the region of interest to cause ablation of at least a portion of the tissue sample at each of those locations. The ablation of the tissue at each location generates a gas phase sample that can be ionized to generate ions, which can in turn be detected and analyzed using a mass spectrometer. For example, similar to the analysis of the ablated portions for identification of the region of interest, the gas phase sample corresponding to each location can be transferred via a carrier gas, e.g., helium, into an ion source, e.g., an inductively coupled plasma ion source, of a mass spectrometer in which at least a portion of the gas phase sample is ionized to generate ions. For example, the metal tags associated with antibodies that exhibit specific binding to one or more surface markers associated with cell types of interest can be ionized. The ions are detected via a downstream mass analyzer, e.g., a ToF mass analyzer, which generates mass signals corresponding to the ions. The mass signals can be indexed relative to the respective ablated locations giving rise to those signals.

In various embodiments, the mass signals can be analyzed to generate information regarding the presence of cell types of interest in the ablated locations. For example, as noted above, the detection of ions corresponding to one or more tags can indicate the presence of one or more cell types of interest associated with those tags in a particular ablated location. Such information associated with the ablated locations can be utilized to provide an image of the region of interest. For example, the image can provide the spatial distribution of one or more cell types of interest in the region of interest.

By way of illustration, FIG. 4 shows a plurality of locations of the tissue sample (herein referred to also as imaging locations), which are designated by red crosses, that are ablated with the ablated material analyzed to determine whether one or more target cell types of interest are present in each of those locations. More specifically, the sample holder can be moved relative to the radiation beam so as to expose, sequentially, the imaging locations to the pulsed laser radiation to cause ablation thereof. In this embodiment, the imaging locations are positioned side-by-side and interleave a portion of the locations utilized for the identification of the region of interest.

In some embodiments, during the imaging process (e.g., during an imaging mode), the locations that were previously ablated for identification of the region of interest (e.g., during a survey mode) are not re-ablated. Rather, the mass signals acquired previously for those locations are employed for generating the image of the region of interest. Alternatively, in other embodiments, during the imaging process, all locations within the region of interest, including those that were previously ablated for identification of the region of interest, are ablated to generate mass signals that can be analyzed for the formation of the image. By way of example, in some embodiments, the ablation of the locations utilized for identification of the region of interest can result in ablation of a top layer of the specimen at those locations. Subsequently, during the imaging mode, the remainder (or a portion of the remainder) of the material at those locations may be ablated. In some embodiments, during the imaging mode, if an ablation spot falls onto a spot that had been previously ablated in the fractional sampling step, the data acquired in the second ablation will be discarded and the data obtained during the first ablation is employed for imaging. In some embodiments, such an arrangement can provide certain advantages. For example, such an arrangement allows configuring the laser firing at equal intervals without skipping certain spots. Further, in some embodiments, the ablated spots generated during the survey mode are non-overlapping, thus justifying the use of data acquired during the first ablation in the survey mode to complement the data generated during the imaging mode. In other words, if the ablated spots do not overlap, a signal obtained for a particular location during the survey mode or the imaging mode pass can be equally useful for generating an image.

In various embodiments, both in the case in which the re-ablation of the previously ablated locations is not performed during the imaging mode as well as in the case in which the ablation of all locations across the region of interest including those that had been previously ablated is performed, the locations identified for ablation for obtaining an image of the region of interest can be selected so as to cover the entire region of interest.

One advantage of the present teachings is that the ablation of the locations within the region of interest during the imaging mode does not require re-registration of the radiation, e.g., the laser beam, relative to the reference points identifying the locations that need to be ablated. In particular, the specimen remains on the specimen holder and its location on the holder does not change between the fractional survey mode and the imaging mode for an ROI on the same sample.

The unchanged position of the specimen on the holder in combination with the reproducibility of the XYZ movable stage used for ablation, which typically has a precision of 1 micron or better, allows the spots to be ablated during the imaging mode to be well within the respective spots ablated during the survey mode, especially because the spot sizes are greater than 1 micron. For example, when the ablated spot sizes of 5 microns are employed during the survey mode, a positioning error of less than 1 micron is inconsequential in data acquisition.

As noted above, it is conventionally accepted in the art that an ablation spot size of 1 micron or less is needed to adequately describe cell boundary and deduce cellular shapes for typical cells. However, it has been surprisingly found that an ablating radiation beam spot size at the specimen surface that is larger than the spatial steps needed to resolve typical cell sizes, e.g., a beam spot having a diameter greater than 1 micron, e.g., a diameter in a range of greater than 1 micron to about 5 microns, can be utilized to obtain the required information, e.g., the type of cell types present in each interrogated location, for forming an image of the region of interest. This is in contrast to conventional teachings in the art that the beam spot size at the specimen surface for causing ablation must be less than the typical size of cell types of interest to be able to unambiguously identify cell types of interest via cell segmentation and integration of signals within cell boundaries across a region of a specimen. In other words, conventionally, those skilled in the art considered the use of an ablation spot size greater than 1 micron as rendering the identification of different cell types impractical.

However, as discussed in the present disclosure, it has been found that the mass data generated via ablation of large portions of a biological specimen, can nonetheless be processed to arrive at the desired imaging information, e.g., the distribution of certain cell types across the region of interest, identification of regions of interest, and/or the information on communities of cells generated by neighborhood analysis algorithms.

In some embodiments, the classification of each ablation spot having a size of greater than 1 micron (herein also referred to as a pseudo cell) can be achieved based on detection or absence of detection of a particular phenotypic signal, e.g., particular markers such as protein surface markers. Such an approach can be based on comparing a measured phenotypic signal with a predefined threshold to determine, e.g., whether the pseudo cell is negative or positive for a given marker. By way of example, in some embodiments, thresholds for each marker (each channel) can be selected from a template for a specific analysis run (screening using the same set of reagents)

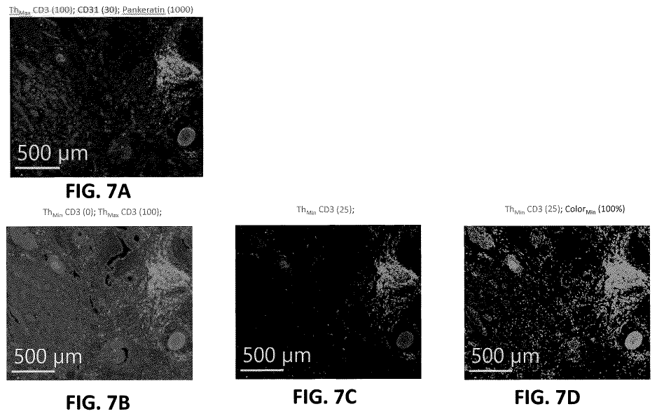

By way of illustration, FIGS. 7A, 7B, 7C, and 7D show examples of identification of various markers based on comparison of mass signal intensities of metal tags coupled to antibodies that exhibit specific binding to those markers relative to predefined thresholds. More specifically, the markers in this example include CD3, CD31 and Pankeratin. More specifically, FIG. 7A provides an overview. FIG. 7B shows ion signals per pixel for CD3 channels as recorded. FIG. 7C in turn shows the same data after zeroing the signals below threshold, which now appear as black. FIG. 7D shows the data from FIG. 7C is a binary image in which all the pixels having a value above the threshold (CD3+) have been assigned the value ‘1’ and all the pixels having a value below the threshold (e.g., CD3−) have been assigned the value ‘0’.

In other embodiments, the classification of the pseudo-cells can be achieved using clustering algorithms. By way of example, a clustering algorithm known as FlowSOM may be utilized to combine the pseudo-cells into populations located in a multidimensional signal space in proximity of one another.

In various embodiments, subsequent to the classification of the pseudo-cells, a neighborhood analysis can be conducted, e.g., to determine what classes of cells are neighbors of a given cell type. Compartments of interest could be identified using neighborhood analysis of classified pixels. In addition, in some embodiments, a neural network can be trained to classify compartments with barcoded pixels. Marker expressions can be calculated in each compartment.

In some embodiments, the desired imaging information can include, for example, the density of certain cell types, co-location and counter location probabilities for certain cell types and other metrics, such as those that can be based on neighborhood analysis. By way of example, such imaging information can be employed for medical diagnosis, prognosis associated with a treatment, survival rates, recommended medical interventions, among others.

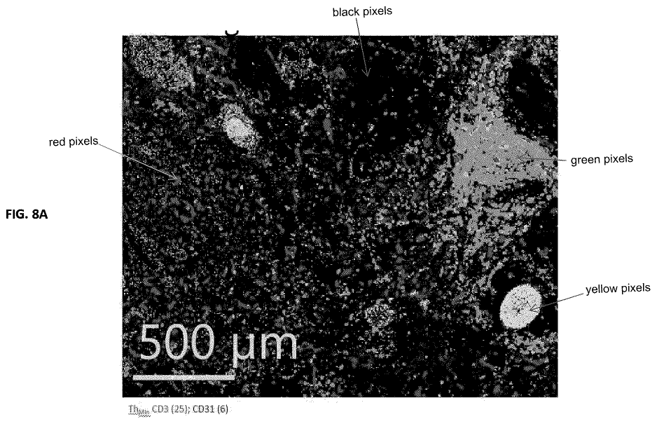

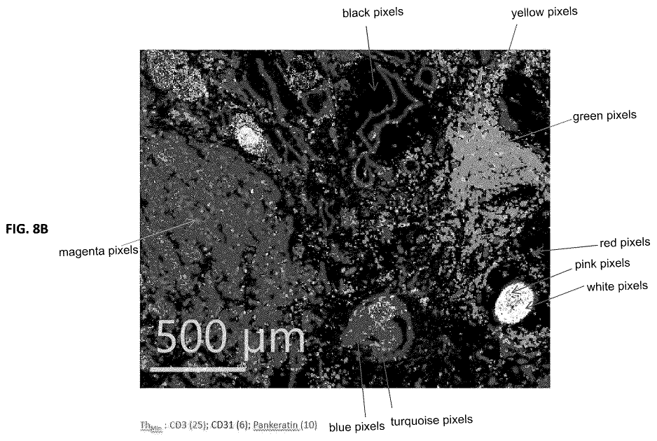

By way of further illustration, FIG. 8A depicts a plurality of pseudo-cells generated according to an embodiment of the present teachings in which the use of two mass channels has led to generation of four categories of pixels: (1) Black pixels corresponding to CD3⁻ and CD31⁻; (2) Green pixels corresponding to CD3⁺ and CD31⁻; (3) Red pixels corresponding to CD3⁻ and CD31⁺; and (4) Yellow pixels corresponding to CD3⁺ and CD31⁺. A variety of metrics can be derived using the information encapsulated by the classification of the pseudo-cells based on the above phenotypic signals. By way of example, the frequencies of different pixel populations can be determined and plotted as frequency maps. Co-locations and counter-localizations of various cell types can be determined based on the above phenotypic signals. Further, a neighborhood analysis of the pixels can be performed.

FIG. 8B provides another example of classification of pseudo-cells generated in accordance with an embodiment of the present teachings using three mass channels that has led to the following eight categories of pixels: (1) Black CD3−, CD31−, Pank−; (2) Green CD3+, CD31−, Pank−; (3) Red CD3−, CD31+, Pank−; (4) Yellow CD3+, CD31+, Pank−; (5) Blue, CD3−, CD31−, Pank+; (6) Turquoise CD3+, CD31−, Pank+; (7) Magenta CD3−, CD31+, Pank+; and (8) White CD3+, CD31+, Pank+. A variety of metrics can be derived from such pseudo-cell classifications, such as those described above.

One advantage of the methods according to the present teachings for imaging a biological specimen, e.g., in a manner discussed above, is that such methods require processing of fewer pixels than conventional methods, thus improving the speed of data collection and analysis while providing informative data analytics.

The detection of the region of interest as well as the use of large ablation spots and even larger spacing between the ablation spots for the detection of the region of interest as well as imaging that region can significantly expedite the imaging of a biological specimen relative to conventional techniques while allowing the formation of an image with sufficient accuracy and resolution, e.g., a resolution of better than 5 microns, such that image can be utilized for analysis of a variety of biological samples, such as, tissue, blood, and bone section samples. For example, it has been found surprisingly that in various embodiments obtaining an image with a 5-micron spatial resolution can provide information about a biological specimen that is substantially on par with the information that can be obtained using a 1-micron spacing, while improving the speed of image acquisition by a factor of 25.

In some embodiments, a three-dimensional (3D) tomographic image of a biological specimen, e.g., a tissue specimen, can be generated by imaging sequential serial sections of the specimen using imaging mass cytometry or imaging mass spectrometry. For each section, e.g., a layer having a thickness in a range of about 30 nm to about 10 mm, can be surveyed during a fractional survey mode in accordance with the present teachings to identify a region of interest within that section. More specifically, as discussed above, a plurality of reference locations can be identified for ablation such that the collection of the ablated locations forms a fraction of that layer. In other words, the ablation locations do not constitute the entirety of that layer, but rather correspond to a fraction of the layer.

The mass signals associated with the ablated locations are analyzed in a manner disclosed herein to identify those locations that are part of a region of interest, which in the 3D case can be considered as a volume of interest (VOI). Subsequently, an image of the region of interest is generated based on ablation of a plurality of locations within that region and analyzing the gas phase samples generated via ablation using the present teachings, e.g., using imaging mass cytometry or imaging mass spectrometry. In other words, the survey mode can be followed by producing pseudo-cell data for the VOI. Such data can be processed by cell classification and neighborhood analysis in 3D. An example of a VOI in a biological sample is a blood vessel or a fiber or a nerve filament.

This process is repeated for each section, i.e., each layer, to form an image of that layer and the images of the different layers are indexed with respect to position of that layer (e.g., the depth of each layer relative to the surface of the biological sample) to form a 3D image of the biological sample.

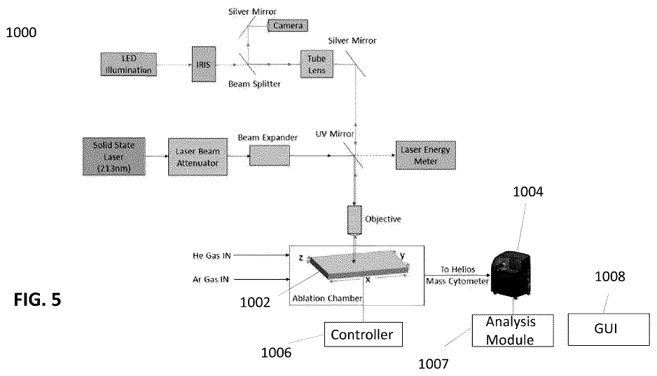

FIG. 5 schematically depicts an example of an imaging system 1000 according to an embodiment that can be configured to perform the identification of a region of interest and imaging of that region in accordance with various embodiments. The imaging system 1000 includes a sample holder 1002, e.g., a microscope slide, that is held on an XYZ positioning stage. In this embodiment, the X and Y axes are controlled using high-precision piezo motors or any other suitable linear motors, e.g., with a 50-nm positioning repeatability, while a piezo-driven flexure actuator controls the Z axis, e.g., with a 300-nm positioning accuracy. The imaging system further includes a hermetically sealed ablation cell that is filled with a high purity helium gas or any other suitable gas mixture (e.g., a mixture of 3% H₂ and 97% He). The output of a pulsed, 5^{th} harmonic Nd:YAG (213 nm), diode-pumped solid state (DPSS) laser is focused using a Schwarzschild objective through a UV-grade fused silica window onto the surface of the microscope slide.

A laser beam attenuator is used to adjust the energy of the laser pulses reaching the sample positioned on the microscope slide. An LED illumination source generating visible radiation can be used for visual inspection of a specimen under analysis. The radiation generated by the LED illumination source passes through an iris to reach a beam splitter. A portion of the illuminating radiation passes through the beam splitter and a lens tube to be reflected by a silver mirror to propagate co-linearly with the UV radiation to be focused via the objective onto the sample holder. Another portion of the LED light is directed by the beam splitter onto a silver mirror, which in turn reflects the light onto a camera. The ablation chamber is in communication with a mass cytometer 1004. A controller 1006 can control the motion of the sample holder to allow exposure of various locations on the surface of the sample holder to the UV radiation.

Ablation of the exposed locations occurs when the intensity of the focused UV laser light exceeds the ablation threshold of the material. Helium flows from the ablation chamber through a small aperture, where it intersects an argon gas stream that redirects the ablated material and carries it through a tube into an inductively coupled plasma (ICP).

An analysis module 1007, e.g., a standalone computer or a computing platform integrated into the mass cytometer, can be configured to perform processing of the mass signals generated via detection of the ions generated by the ICP, e.g., in a manner discussed herein, to form an image of a region of interest of the biological specimen.

A graphical user interface (GUI) 1008 allows a user to communicate with the imaging system. For example, the GUI can provide a display for presenting an identified region of interest to a user and can further allow the user to manually select portions of the region of interest to be imaged.

Defocusing the laser spot on the target can be accomplished by a variety of methods. In one embodiment the Z position is shifted from the position recommended by AutoFocus module for tightest focusing. In another embodiment, an optical element inserted into the beam expander is adjusted in its position along the axis to effect defocusing of the laser beam at the Z location recommended by the AutoFocus module. In yet another configuration a beam shaping set of optics is inserted into the light path of the laser to effect uniform energy distribution on the surface of the slide at the Z location recommended by the AutoFocus module.

In some embodiments, the fractional sampling survey may be omitted and optical imaging can be employed to identify the biological sample on a holder (microscope slide). The imaging mode can then be performed on the sample using ablation spot sizes that are greater than 1 micron. Even without the fractional sampling survey, the larger spot sizes utilized for imaging can speed up the data acquisition. Such an optical detection can also be used for identifying various sections of a biological sample when performing 3D imaging as discussed above.

In contrast to ablation spots that are 1 micron or less in size, the use of larger ablation spots provides additional choices for profiles of radiation beams that can be employed. For example, in some embodiments, suitable optics can be employed for causing a substantially uniform ablation of the ablation spots. In other words, the amount of the material ablated across an ablation spot can be substantially uniform. For example, in some embodiments, a flat top radiation beam can be utilized to provide substantially uniform ablation spots. By way of example, a flat top beam with a circular cross-sectional profile with a diameter of greater than 1 micron, e.g., with a diameter in a range of about 5 or about 7 microns, can be utilized for this purpose. In some embodiments the laser beam can be shaped in a uniform (Flat Top) distribution of hexagonal or square profile instead of the traditional round profile. Creating suitable shapes of illumination becomes easier when the spot size significantly exceeds 1 mm, as for example, is the case for the 5 mm spot.

In some embodiments, each location of a specimen may be irradiated with multiple radiation pulses, e.g., multiple laser pulses, to achieve a desired ablation of the material at that location. In other words, a single pixel can be ablated by more than one laser shot. In some embodiments, this can be accomplished with a high repetition rate laser, e.g., repetition rate in a range of about 10 kHz to about 10000 kHz. By way of example, in some embodiments, such a laser can direct a burst of laser shots at each location to be ablated such that each shot ablates a certain layer of material at that location. In another embodiment, the laser spot is smaller than the area of the pixel and optics with rapid steering can be used to fill the area of the pixel with laser shots. For example, the teachings provided in U.S. Published Application No. US2021/0333173A1 titled “High speed modulation sample imaging apparatus and method,” which is herein incorporated by reference in its entirety, can be utilized for implementing such rapid steering.

Those having ordinary skill in the art will appreciate that various changes can be made to the above embodiments without departing from the scope of the present teachings.

What is claimed is:

1. A method for imaging a biological specimen, the method comprising:
defining a first plurality of reference location points across a surface of the biological specimen,
directing ablating radiation to the biological specimen to ablate a fraction of the specimen at a first plurality of specimen locations corresponding to the defined first reference location points or a subset thereof to ablate at least a portion of the specimen at each of said first plurality of specimen locations, thereby generating a gas phase sample from each of said first plurality of specimen locations,
ionizing each of the gas phase samples to generate ions corresponding to that gas phase sample,
acquiring one or more mass signals corresponding to ions associated with each of the ablated portions, and
identifying at least one region of interest based on analysis of the mass signals

2. The method of claim 1, wherein the step of identifying the at least one region of interest comprises comparing each of the mass signals with at least one threshold reference defined based on at least one phenotypic signal to determine whether the specimen location corresponding to that mass signal is within the region of interest.

3. The method of claim 2, wherein said at least one phenotypic signal comprises a plurality of phenotypic signals and the at least one threshold reference comprises a plurality of threshold references each corresponding to one of the phenotypic signals and wherein the method further comprises classifying each of the ablated locations in a multidimensional signal space based on said comparison.

4. The method of claim 3, further comprising performing a neighborhood analysis of the classified ablated locations to identify the at least one region of interest.

5. The method of claim 1, wherein said at least one region of interest is identified without utilizing fluorescent imaging.

6. The method of claim 1, further comprising utilizing any of image mass cytometry and image mass spectrometry to generate an image of the identified region of interest.

7. The method of claim 1, wherein said ablating radiation is configured to ablate a top layer of the specimen at one or more of said first plurality of locations.

8. The method of claim 7, wherein said top layer has a thickness in a range of about 10 nm to about 1000 nm.

9. The method of claim 6, wherein the step of obtaining an image of the identified region of interest comprises:
directing ablating radiation to a second plurality of locations within the region of interest to generate a gas phase sample from each of said second plurality of portions,
ionizing said gas phase samples to generate ions corresponding to each of said second plurality of specimen locations,
acquiring one or more mass signals corresponding to ions associated with each of the second plurality of specimen locations, and
generating an image of at least a portion of the region of interest based on said mass signals associated with said second plurality of specimen locations.

10. The method of claim 9, wherein the step of directing the ablating radiation to the second plurality of locations is performed without re-registration of the radiation relative to the defined reference location points.

11. The method of claim 9, wherein said biological specimen comprises one or more cell types.

12. The method of claim 11, wherein the step of generating the image comprises analyzing the mass signal associated with each of the second plurality of specimen locations to identify one or more cell types of interest in that location.

13. The method of claim 12, wherein the cell types of interest comprise any of immune cells, structural cells, tumor cells, stroma cells, germinal center cells, blood vessel cells, mesenchymal cells or non-mesenchymal cells.

14. The method of claim 13, wherein said immune cells comprise any of CD3+ and CD45+ cells.

15. The method of claim 12, wherein said step of identifying the one or more cell types of interest is based on identification of at least a phenotypic signal via analysis of the mass signal associated with each of the second plurality of specimen locations.

16. The method of claim 15, wherein said at least one phenotypic signal is associated with any of a target protein, a target DNA, a target RNA, a target molecular structure, a sequence of amino acids, a target lipid structure, a target phosphorylation region, a target sugar region, a naturally occurring substance or element.

17. The method of claim 16, wherein said naturally occurring substance or element comprises any of Selenium and Mercury.

18. The method of claim 16, wherein said at least one phenotypic signal is associated with a drug related substance.

19. The method of claim 16, wherein said at least one phenotypic signal is associated with platinum in a chemotherapy drug.

20. The method of claim 16, wherein said at least one phenotypic signal provides information regarding protein content of different cell types, or tissue compartments.

21. The method of claim 12, wherein the identification of any one of the one or more cell types of interest is based on detection of a mass signal corresponding to a metal tag coupled to an antibody exhibiting specific binding to a surface marker of that cell type of interest.

22. The method of claim 9, wherein said second plurality of locations are different from said first plurality of locations.

23. The method of claim 9, wherein said second plurality of locations contain said first plurality of locations.

24. The method of claim 1, wherein said plurality of reference location points is distributed according to a regular grid.

25. The method of claim 24, wherein said regular grid comprises any of a rectangular, a square, a triangular, and a hexagonal grid.

26. The method of claim 9, wherein any of said first and second ablated locations have a maximum linear dimension in a range of greater than 1 micron to about 20 microns.

27. The method of claim 26, wherein said maximum linear dimension is any of at least 2 microns, at least 3 microns, at least 4 microns, at least 5 microns, at least 6 microns, at least 7 microns, at least 8 microns, at least 9 microns, at least 10 microns, at least 11 microns, at least 12 microns, at least 13 microns, at least 14 microns, at least 15 microns, at least 16 microns, at least 17 microns, at least 18 microns, at least 19 microns, and at least 20 microns.

28. The method of claim 27, wherein said first ablated locations are separated by a distance corresponding to a multiple of said maximum linear dimension.

29. The method of claim 28, wherein said multiple is in a range 2 to 10.

30. The method of any one of claims 27, 28 and 29, wherein said first and second ablated locations have a substantially circular cross-sectional profile and said maximum linear dimension corresponds to a diameter of said substantially circular cross-sectional profile.

31. The method of claim 9, wherein said second set of ablated locations are positioned side-by-side.

32. The method of claim 1, wherein said biological specimen comprises any of a tissue specimen, a bone section, a blood specimen, an organoid section, a cell culture specimen.

33. The method of claim 1, wherein said radiation comprises laser radiation.

34. The method of claim 33, wherein said laser radiation has a wavelength in a range of about 10 nm to about 10000 nm.

35. The method of claim 34, wherein said laser radiation has a wavelength in a range of about 100 nm to about 1000 nm.

36. The method of claim 34, wherein said laser radiation has a beam size at a surface of said specimen in a range of about 1 micron to about 20 microns.

37. The method of claim 29, wherein said laser radiation has a fluence in a range of about 0.001 J/cm² to about 10 J/cm² at the surface of the specimen.

38. The method of any one of claims 33-37, wherein said laser radiation has a Gaussian intensity profile and said beam size corresponds to a full width at half maximum (FWHM) of the Gaussian intensity profile.

39. The method of any one of claims 33-37, wherein said laser radiation has a flat top intensity profile.

40. The method of claim 1, wherein said ablating radiation is configured to generate a substantially uniform ablation of said plurality of locations.

41. The method of claim 1, further comprising utilizing a mass spectrometer for generating said mass signals corresponding to any of said first and said second plurality of specimen portions.

42. The method of claim 41, wherein said mass spectrometer comprises a high parameter mass spectrometer, and wherein optionally said high parameter mass spectrometer comprises a ToF mass spectrometer.

43. The method of claim 1, further comprising generating an optical image of said biological sample with a trace delineating the identified region of interest.

44. The method of claim 43, further comprising utilizing a display of a user interface to present said optical image to a user.

45. The method of claim 44, wherein the user interface is configured to allow a user to select locations within the identified region of interest for imaging.

46. The method of claim 1, further comprising utilizing a digital data processor to analyze the mass signals for identification of the region of interest.

47. The method of claim 7, wherein said specimen is positioned on a specimen holder.

48. The method of claim 47, wherein said specimen holder is moved relative to said radiation to direct the radiation to any of said first and second plurality of specimen locations.

49. The method of claim 1, wherein said radiation comprises pulsed radiation and a plurality of radiation pulses is directed to at least one of said locations for causing ablation of a least a portion of the specimen at that location.

50. The method of claim 49, wherein said radiation pulses are directed to said at least one of the locations at a repetition rate in a range of about 10 kHz to about 10,000 kHz.

51. The method of claim 47, wherein said radiation is directed as a radiation beam to said biological specimen and the radiation beam is moved relative to the specimen holder to ablate any of said first and second specimen portions.

52. A method for identifying at least a region of interest associated with a biological specimen, the method comprising:
ablating a plurality of portions of the specimen with radiation to create a gas phase sample from each portion,
ionizing at least a portion of the gas phase sample from each of the plurality of said specimen portions to generate ions associated with the two or more of the specimen portions,
acquiring mass signals corresponding to the ions associated with the two or more specimen portions, and
identifying the at least one region of interest based on analysis of the mass signals associated with the two or more specimen portions.

53. The method of claim 52, wherein the step of analyzing said mass signals comprises comparing each of the mass signals with a reference threshold to determine whether a respective portion of the specimen is part of the region of interest.

54. The method of claim 53, further comprising classifying any of the specimen portions as being in the region of interest when the mass signal associated with that specimen portion is equal to greater than the reference threshold.

55. The method of claim 52, wherein the step of analyzing said mass signals comprises comparing the two or more specimen portions with one another to determine if any of said two or more specimen portions is part of the region of interest.

56. The method of claim 52, wherein the step of analyzing said mass signals comprises comparing the mass signal associated with at least one of the specimen portions with a mass signal associated with a neighboring specimen portion.

57. The method of claim 52, wherein the step of analyzing said mass signals comprises classifying any of the specimen portions as being in the region of interest when the mass signal associated with that specimen portion in within a predefined range.

58. The method of claim 52, wherein a collection of said plurality of specimen portions corresponds to a fraction of said specimen.

59. The method of claim 52, wherein each of the specimen portions has a maximum linear dimension of greater than 1 μm, and optionally in a range of greater than 1 μm to about 20 μm.

60. The method of claim 52, wherein each of the specimen portions has a maximum linear dimension of at least 2 μm.

61. The method of claim 52, wherein each of the specimen portions has a maximum linear dimension of at least 3 μm.

62. The method of claim 52, wherein each of the specimen portions has a maximum linear dimension of at least 4 μm.

63. The method of claim 52, wherein each of the specimen portions has a maximum linear dimension of at least 5 μm.

64. The method of claim 52, further comprising utilizing a digital data processor to perform the step of analyzing the mass signals.

65. The method of claim 52, wherein said specimen portions are arranged relative to one another according to a regular grid.

66. The method of claim 65, wherein said grid comprises any of a square, a rectangular, a triangular and a hexagonal grid.

67. The method of claim 52, further comprising functionalizing said biological sample with at least one antibody tagged with at least one metal tag, wherein said antibody exhibits specific binding to a target surface cell marker.

68. The method of claim 67, wherein the ionizing step comprises ionizing the metal tag.

69. The method of claim 67, further comprising generating an image of at least a portion of the identified target region using mass signals associated with said at least one metal tag.

70. The method of claim 52, wherein the biological specimen comprises any of a tissue specimen, a bone section, a blood specimen, an organoid section, and a cell culture specimen.

71. A method of identifying one or more regions of interest of a biological specimen comprising:
(a) ablating a portion of a specimen with radiation to create a gas phase sample,
(b) ionizing at least a portion of the gas phase sample,
(c) generating a mass spectrum comprising at least one mass signal from the ionized portion of the gas phase sample,
(d) comparing the at least one mass signal to at least one threshold value defined based on at least one phenotypic signal,
(e) identifying the ablated portion as part of a region of interest when said at least one mass signal is equal to or greater than the threshold value to which that mass signal is compared,
(f) repeating steps (a) to (e) for one or more different portions of the biological specimen, and
(g) identifying one or more regions of interest of the biological specimen based on two or more of the ablated portions identified as part of a region of interest.

72. The method of claim 71, wherein the at least one mass signal comprises a plurality of mass signals.

73. The method of claim 71, wherein said at least one phenotypic signal comprises a plurality of phenotypic signals.

74. The method of claim 73, wherein the comparing step comprises comparing each of the phenotypic signals to a respective one of a plurality of threshold values.

75. The method of claim 71, further comprising acquiring a substantially complete image of the identified one or more regions of interest.

76. The method of claim 75, wherein said substantially complete image of the identified one or more regions of interest is acquired without re-ablating the portions of the specimen that were ablated for identifying the one or more regions of interest.

77. The method of claim 75, wherein said substantially complete image of the identified one or more regions of interest is acquired with re-ablating the portions of the specimen that were ablated for identifying the one or more regions of interest.

78. The method of claim 71, wherein said at least one phenotypic signal is associated with any of a target protein, a target DNA, a target RNA, a target molecular structure, a sequence of amino acids.

79. The method of claim 59, wherein the specimen portions ablated to identify the one or more regions of interest are separated from one another by a distance that is a multiple of a maximum linear dimensional size of the ablated portions.

80. The method of claim 67, wherein said multiple is in a range of about 2 to about 7.

81. A method of generating a three-dimensional tomographical image of a biological specimen, comprising:
defining a plurality of sections of the biological specimen, for each of said sections, performing the following steps:
defining a plurality of reference location points across a surface of the biological specimen,
directing ablating radiation to the biological specimen at a first plurality of sample locations corresponding to a first subset of the defined reference location points to ablate at least a portion of the specimen at each of said locations, thereby generating a gas phase sample from each of said sample locations,
ionizing each of the gas phase samples to generate ions corresponding to that gas phase sample,
acquiring one or more mass signals corresponding to ions associated with each of the ablated portions,
identifying at least one region of interest based on analysis of the mass signals, and
generating an image said at least a portion of the identified at least one region of interest.

82. The method of claim 81, wherein said step of generating the image of the identified at least one region of interest, comprises:
directing ablating radiation to a second plurality of locations within the region of interest and associated with a second subset of said reference location points to generate a gas phase sample from each of said portions,
ionizing said gas phase samples to generate ions corresponding to each of said second plurality of specimen locations,
acquiring one or more mass signals corresponding to ions associated with each of the second plurality of specimen locations, and
generating the image of the at least a portion of the region of interest based on said mass signals associated with said second plurality of specimen locations.

83. A method of imaging a biological specimen, comprising:
obtaining an optical image of a biological specimen disposed on a holder,
directing ablating radiation to a plurality of portions of said biological specimen to generate a gas phase sample from each of said portions,
ionizing said gas phase samples to generate ions corresponding to each of said plurality of specimen locations,
acquiring one or more mass signals corresponding to ions associated with each of the plurality of specimen locations, and
generating the image at least a portion of the biological specimen based on said mass signals associated with said plurality of specimen locations.
